(19) United States
(12) Patent Application Publication
(10) Pub. No.: US 2023/0039140 A1
(43) Pub. Date: Feb. 9, 2023

(54) HIGHWAYS AND ROADS LIGHTING

(71) Applicant: Mohammad Fawaz Abrash, Jeddah (SA)

(72) Inventor: Mohammad Fawaz Abrash, Jeddah (SA)

(21) Appl. No.: 17/792,816

(22) PCT Filed: Jan. 14, 2020
(86) PCT No.: PCT/IB20/00010

§ 371 Date: Jul. 14, 2022

(51) Int. Cl. F21S 8/08; F21S 9/03; F21V 23/04

(52) U.S. Cl. CPC F21S 8/081; F21S 9/035; F21V 23/0464; F21W 2131/103

(57) ABSTRACT

The present invention relates to a lighting unit which is simple manufacturing, installation.

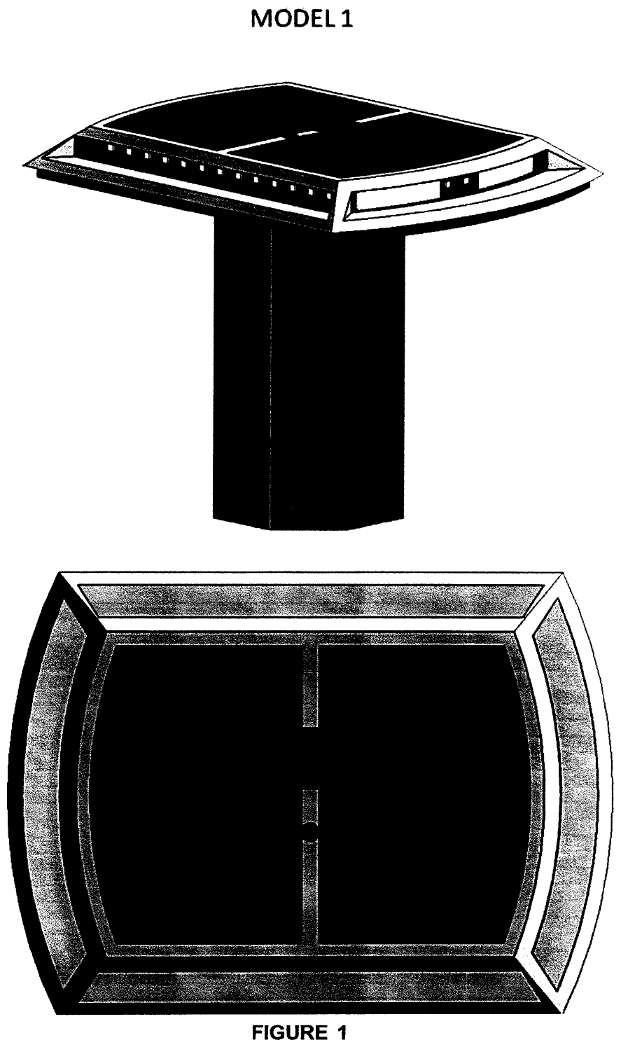

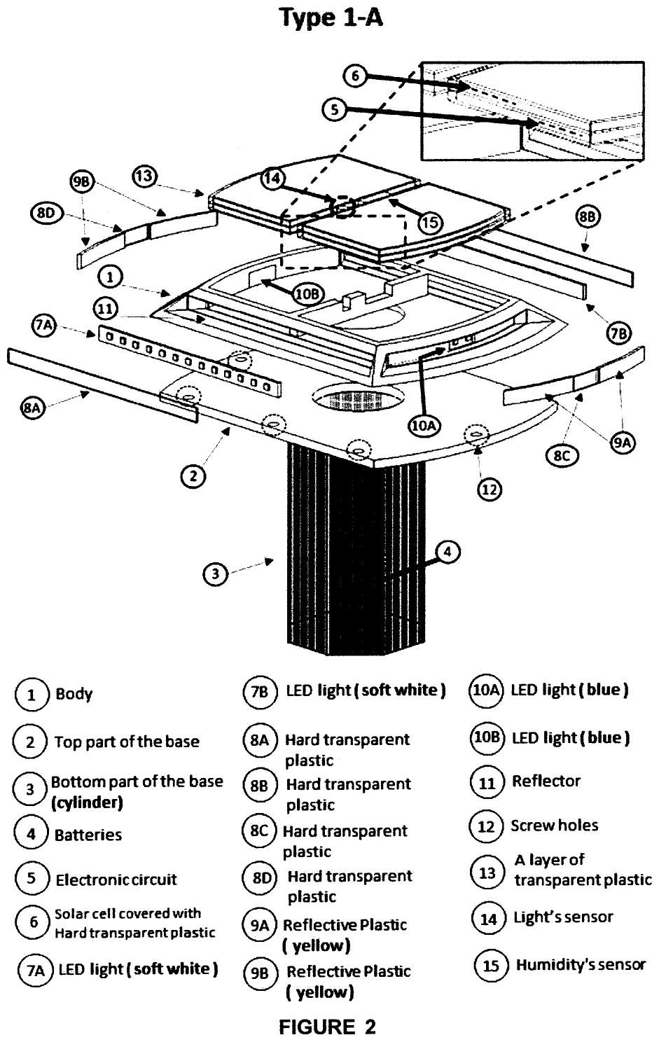

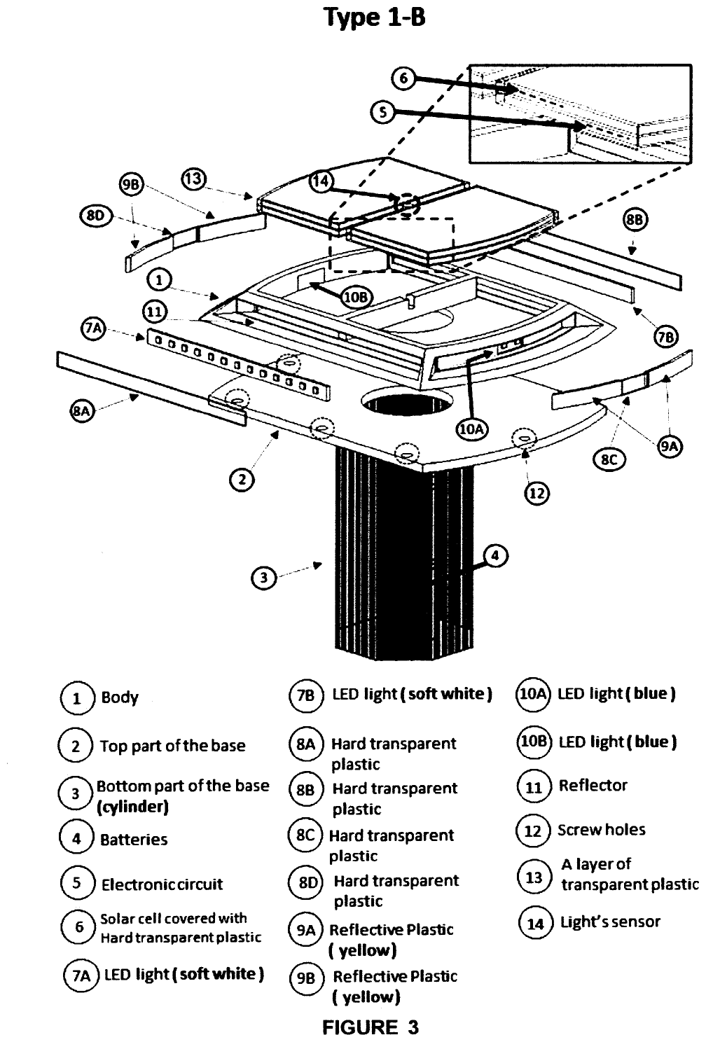

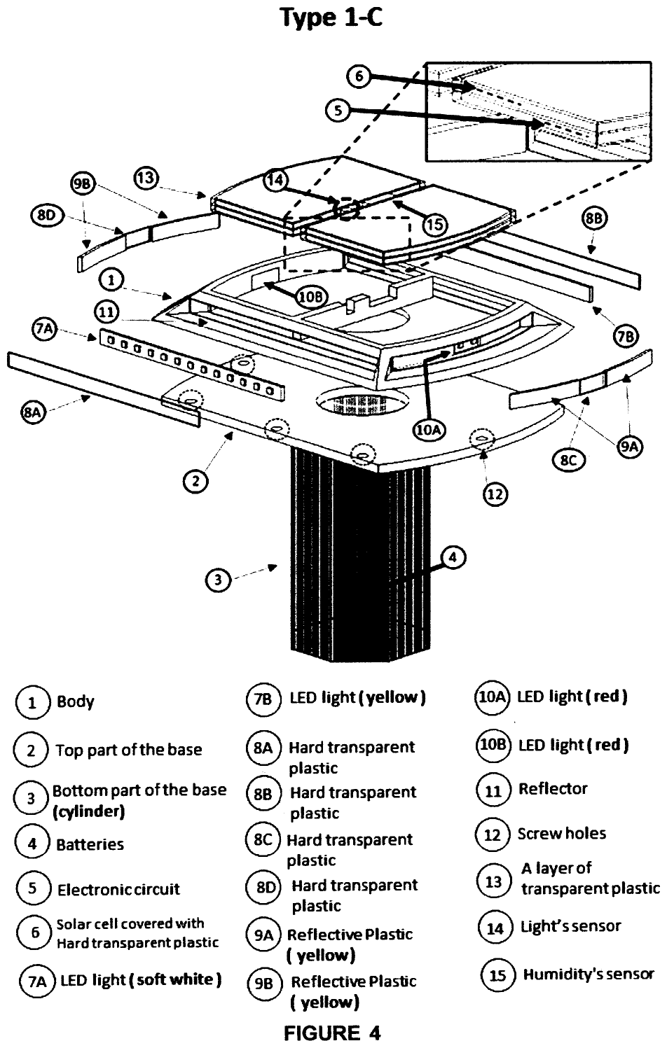

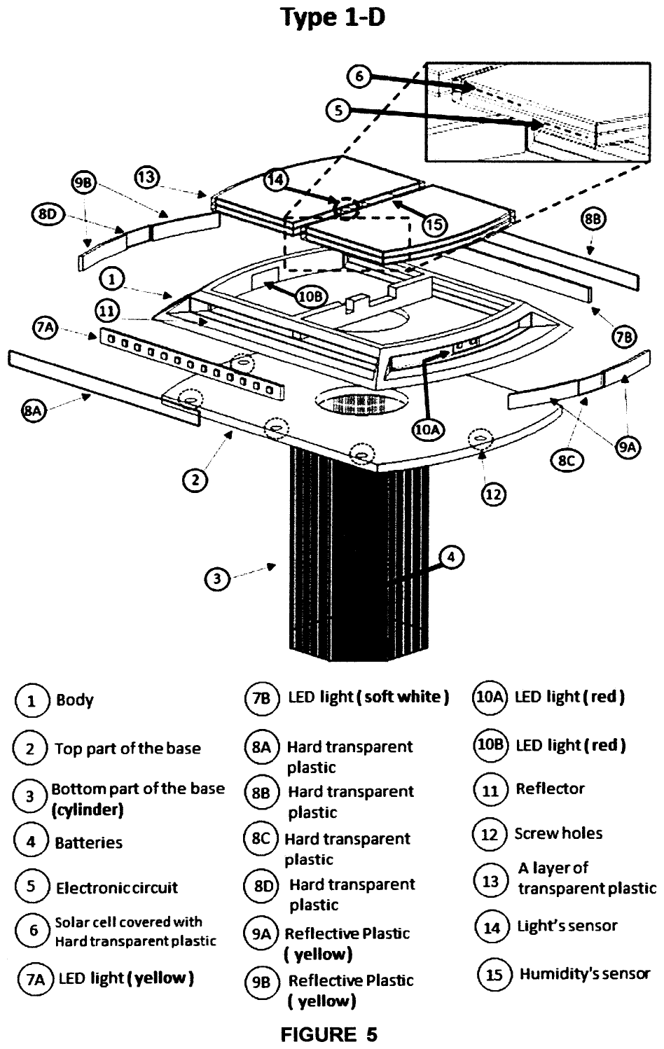

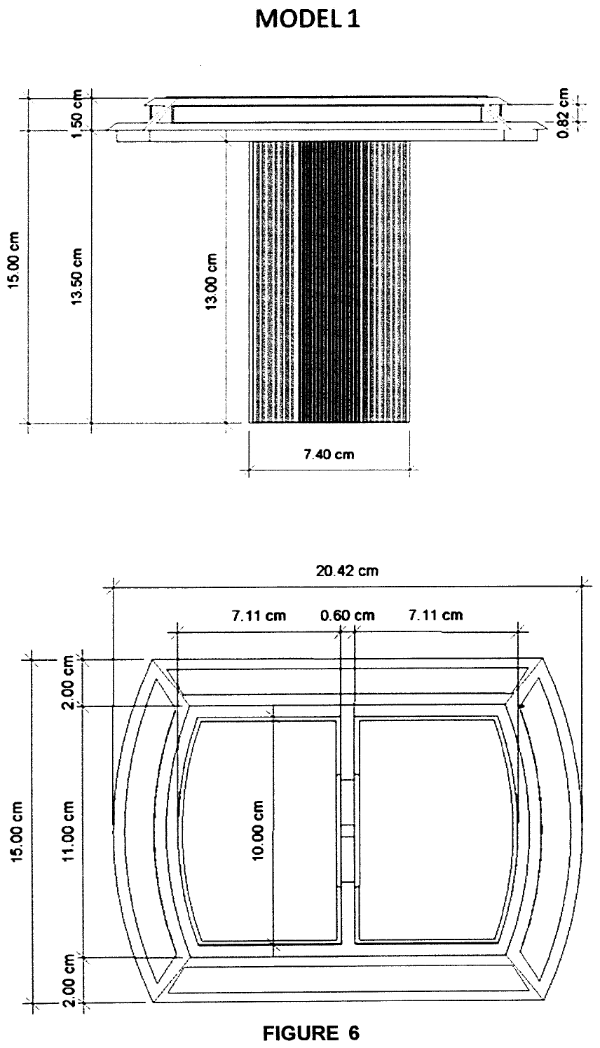

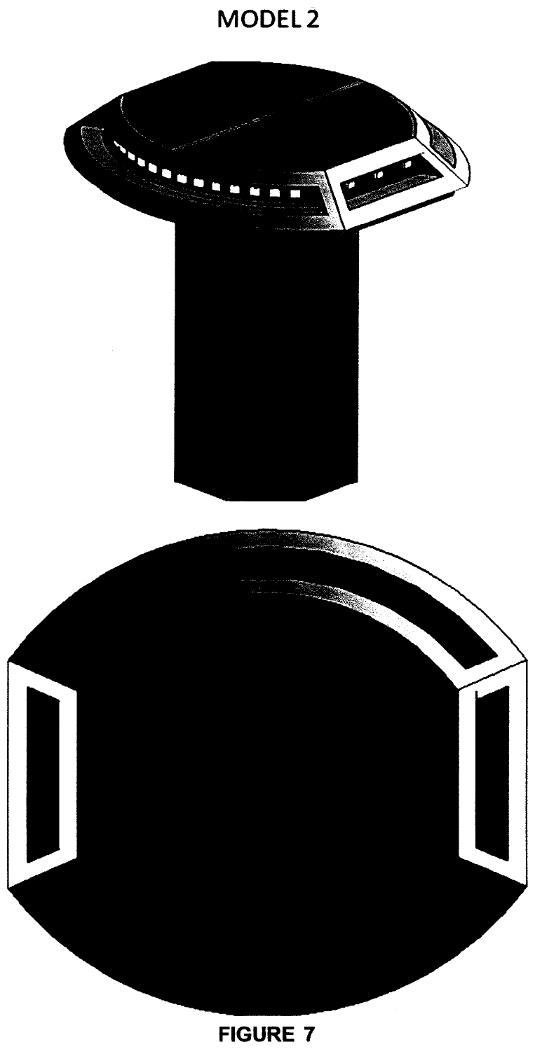

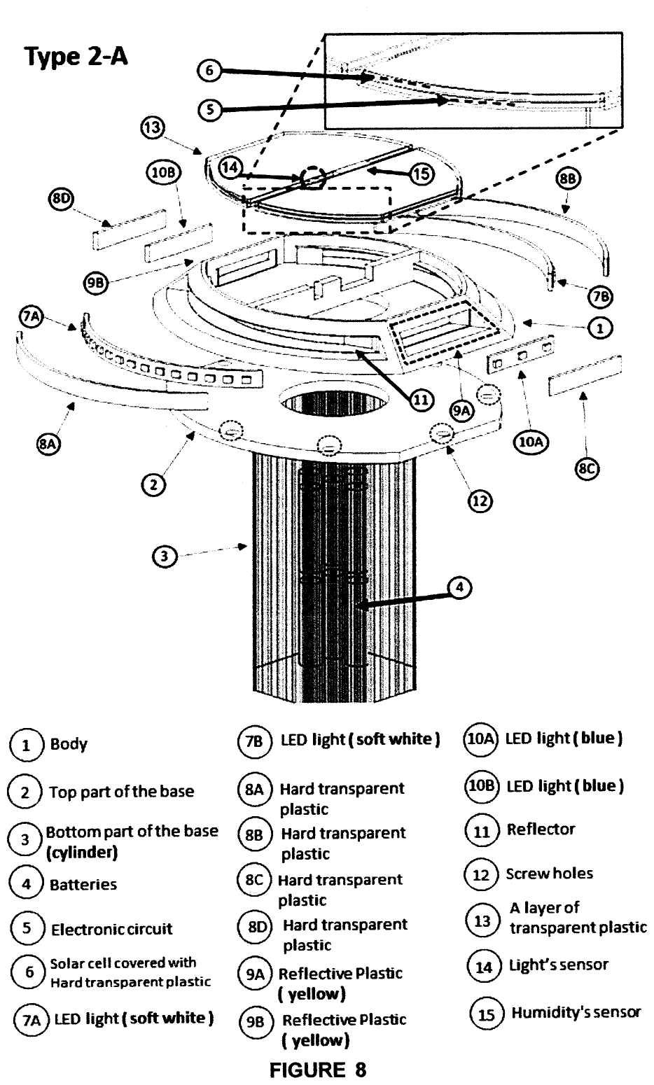

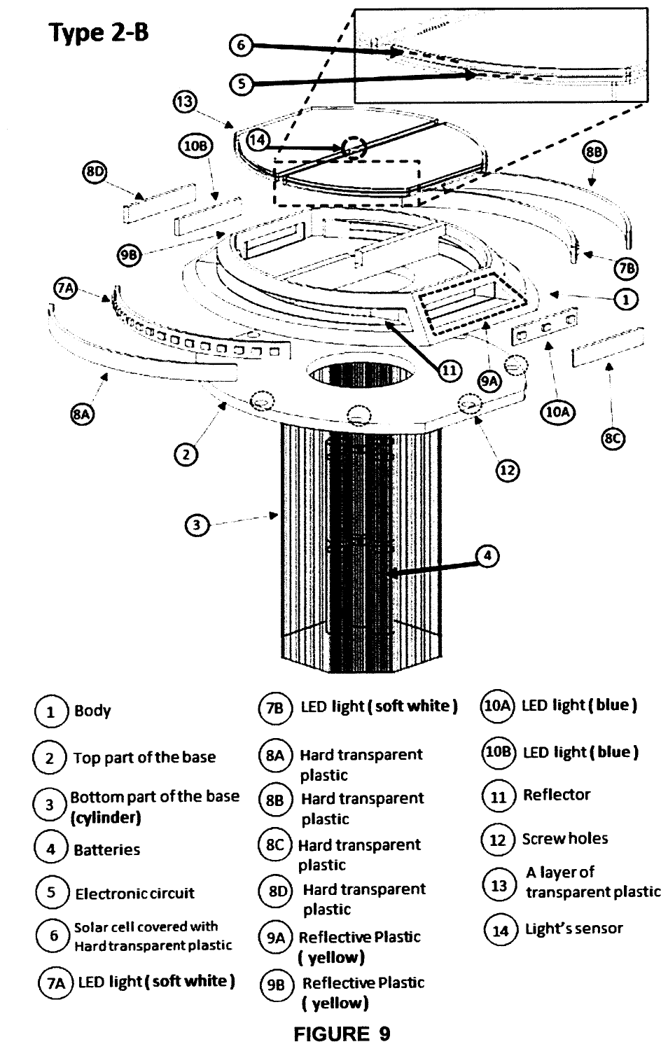

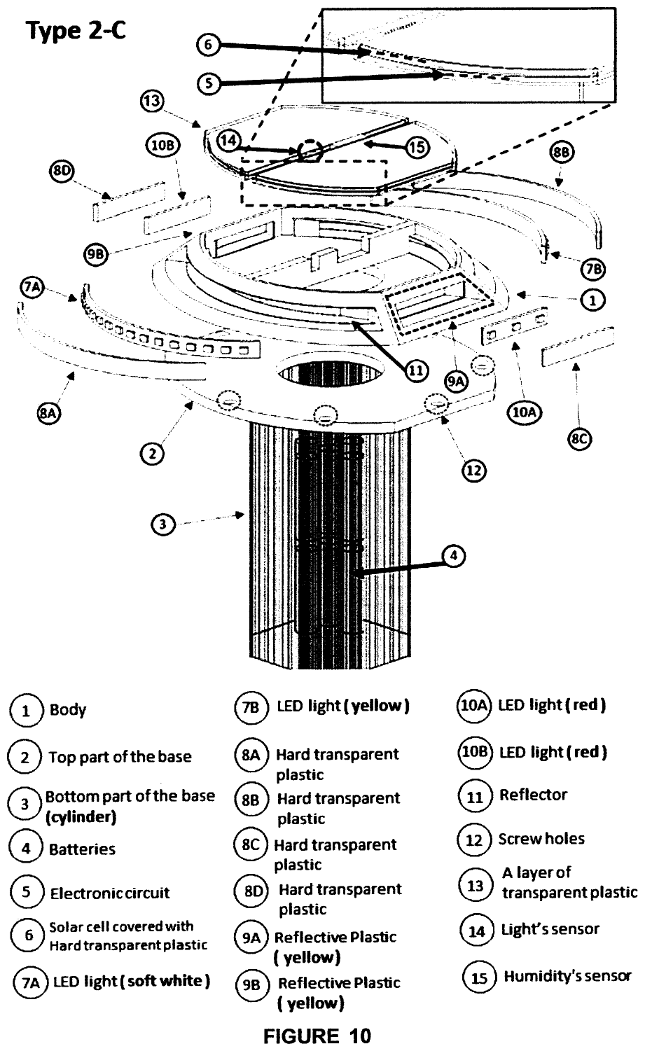

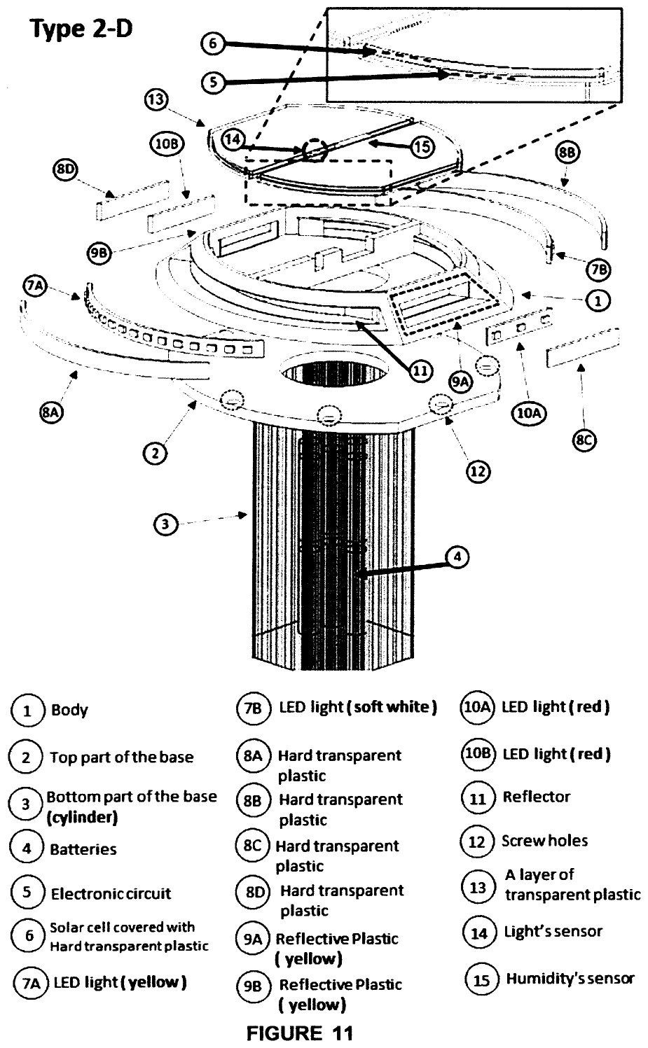

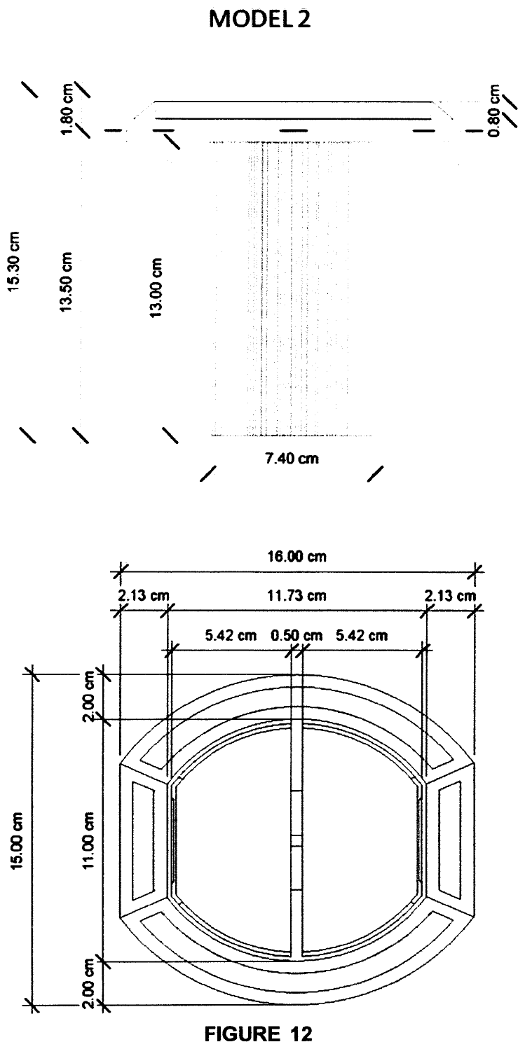

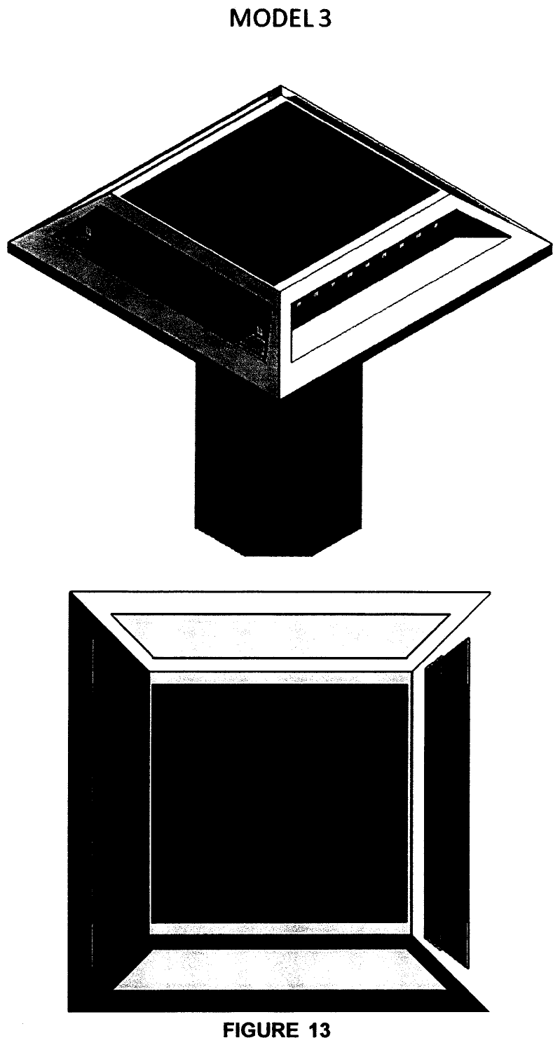

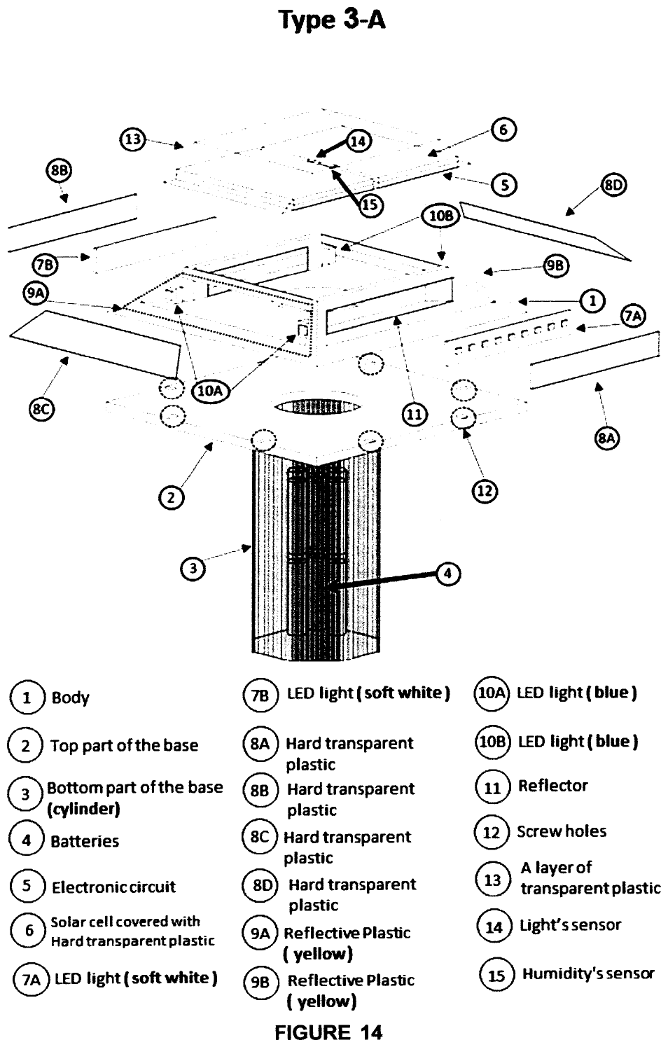

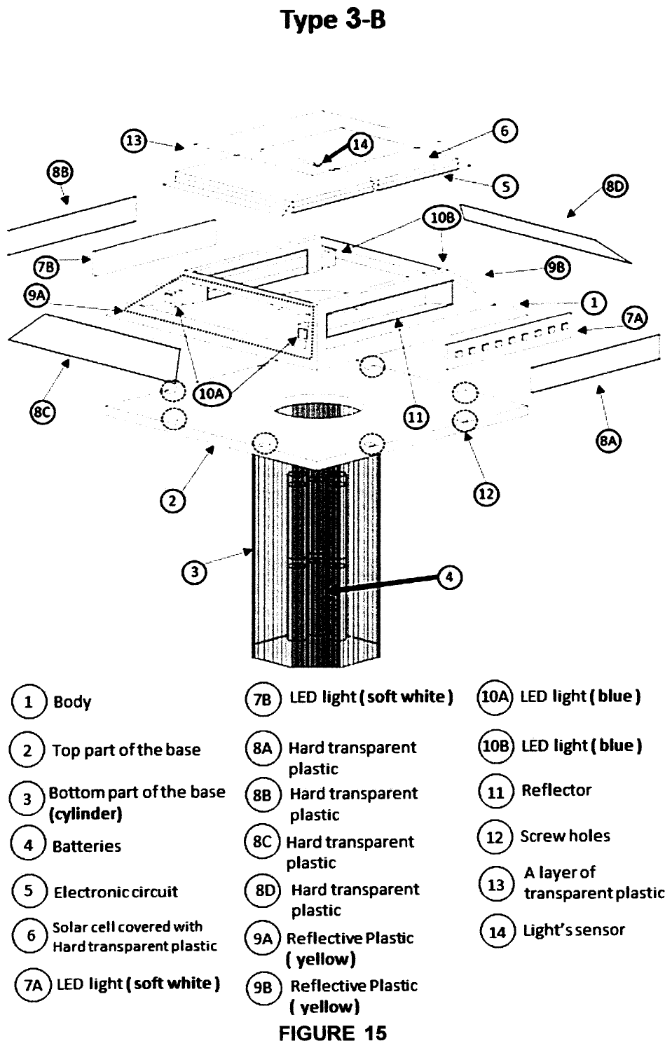

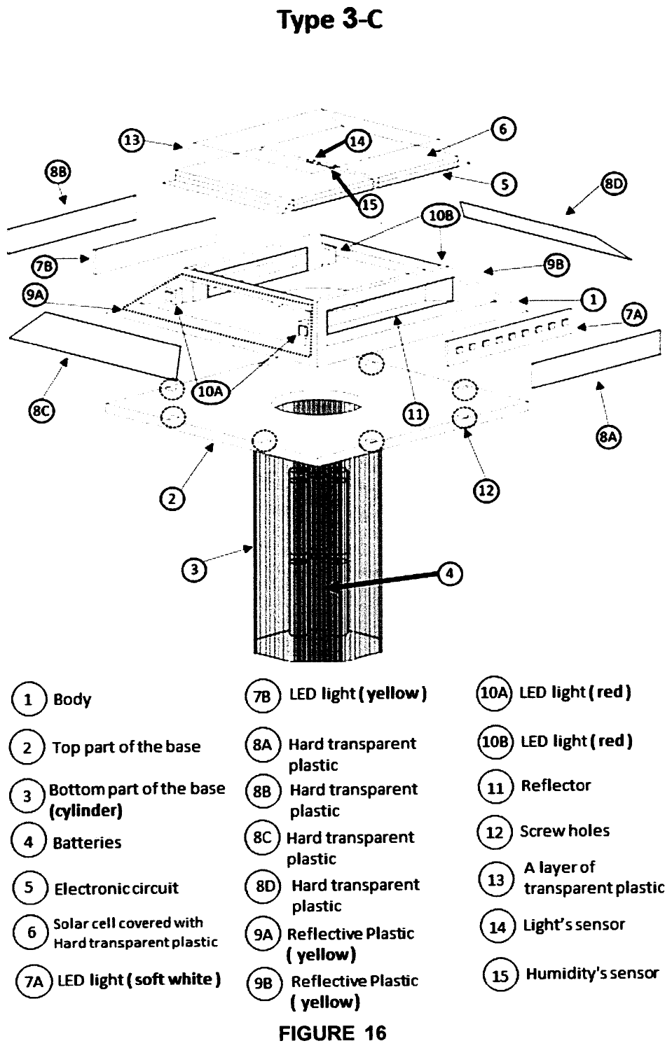

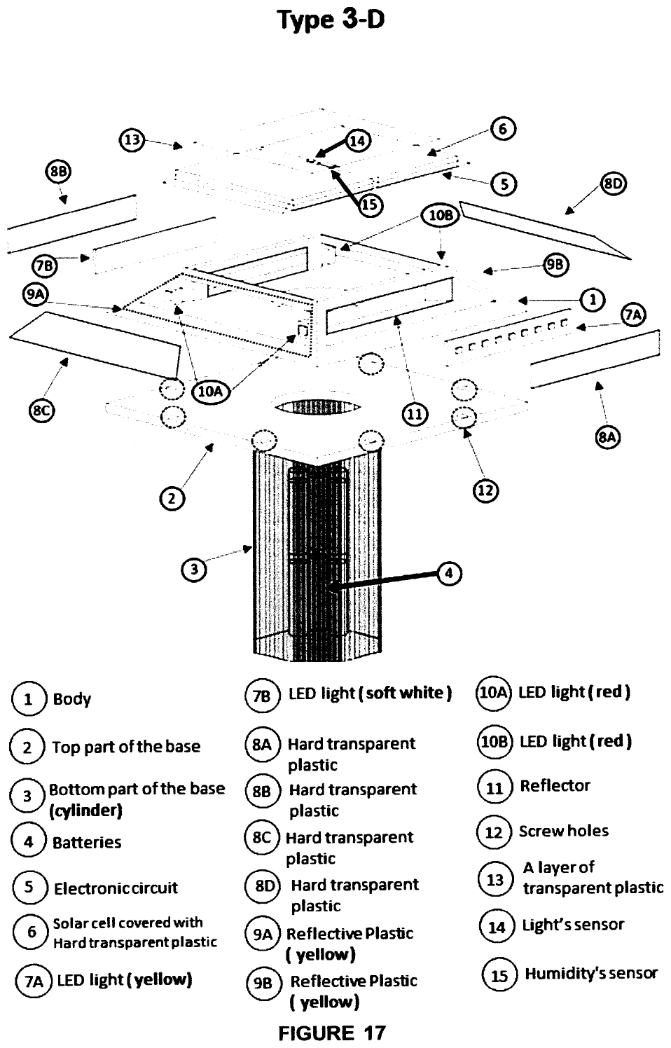

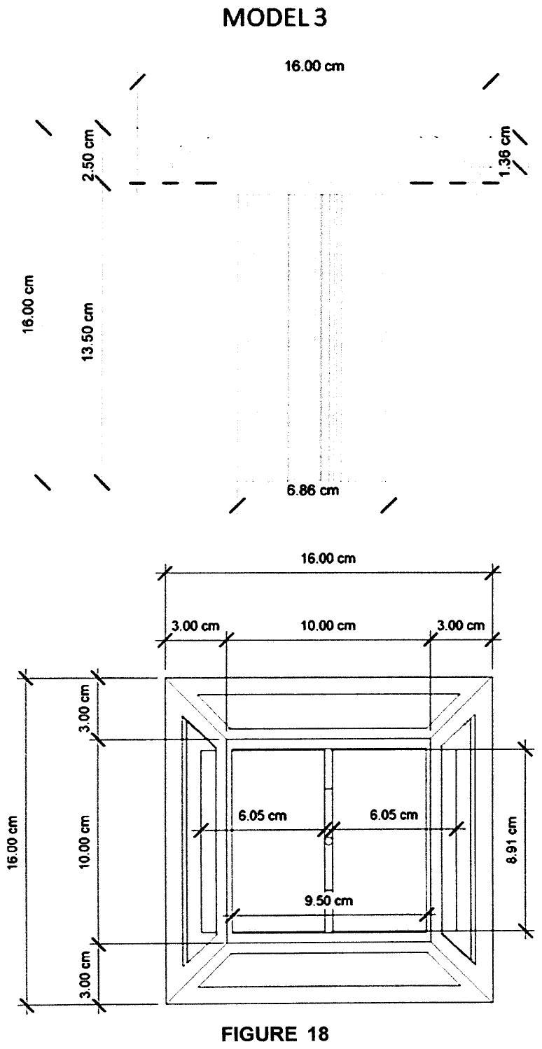

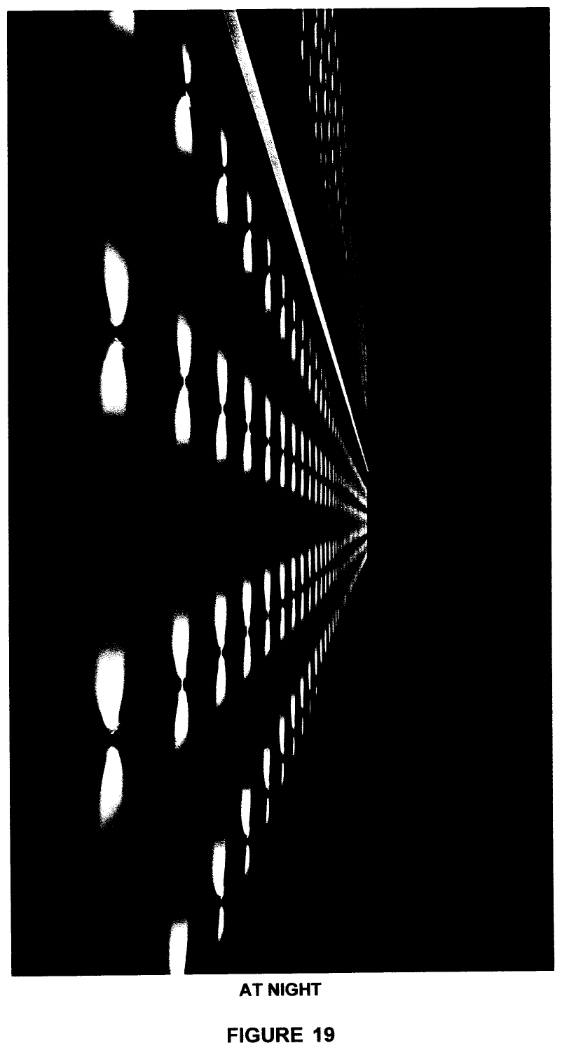

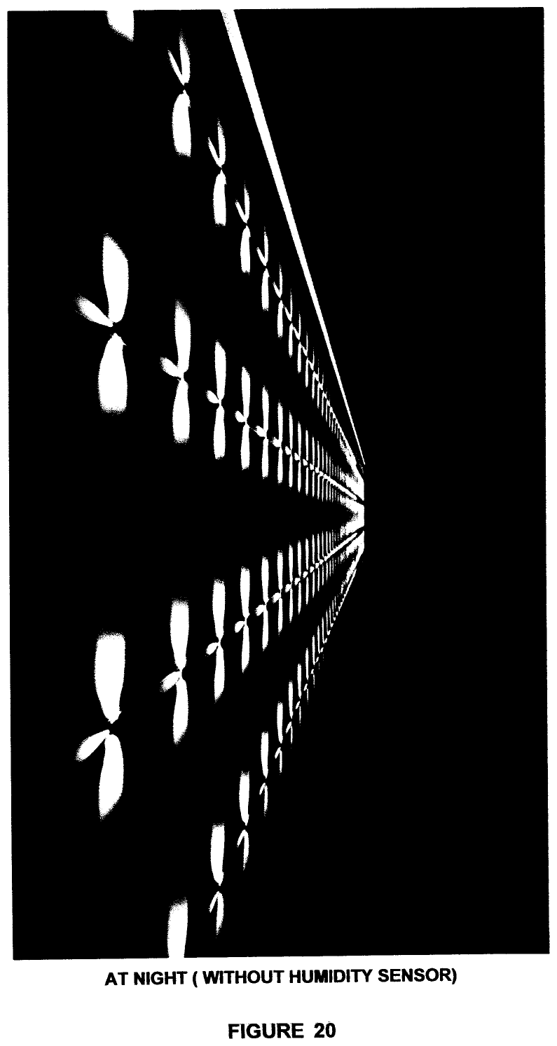

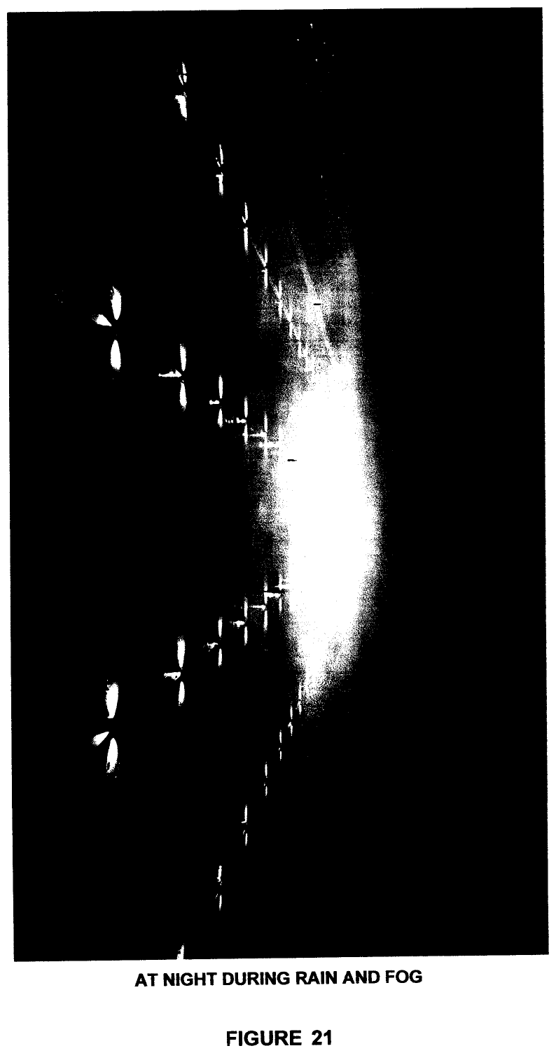

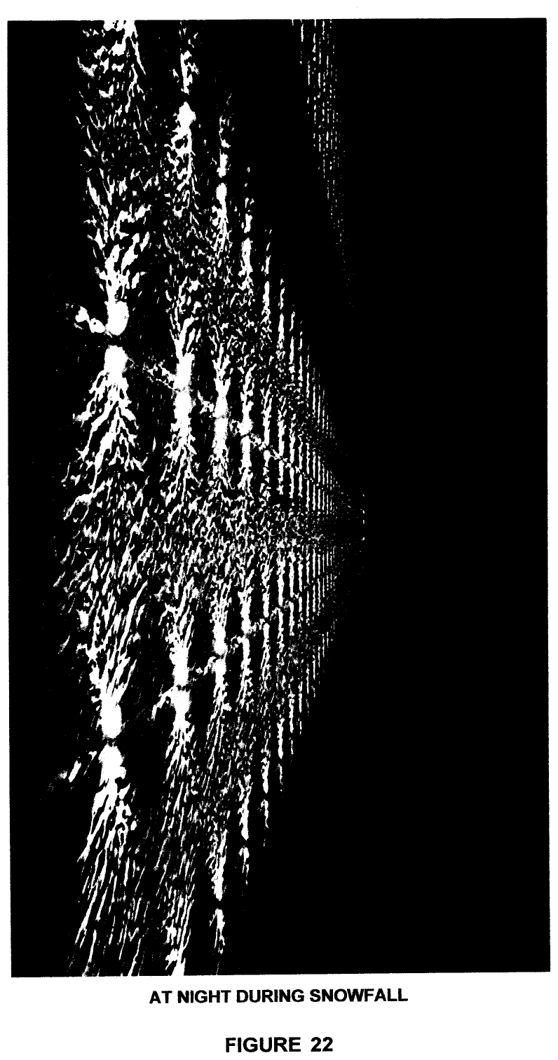

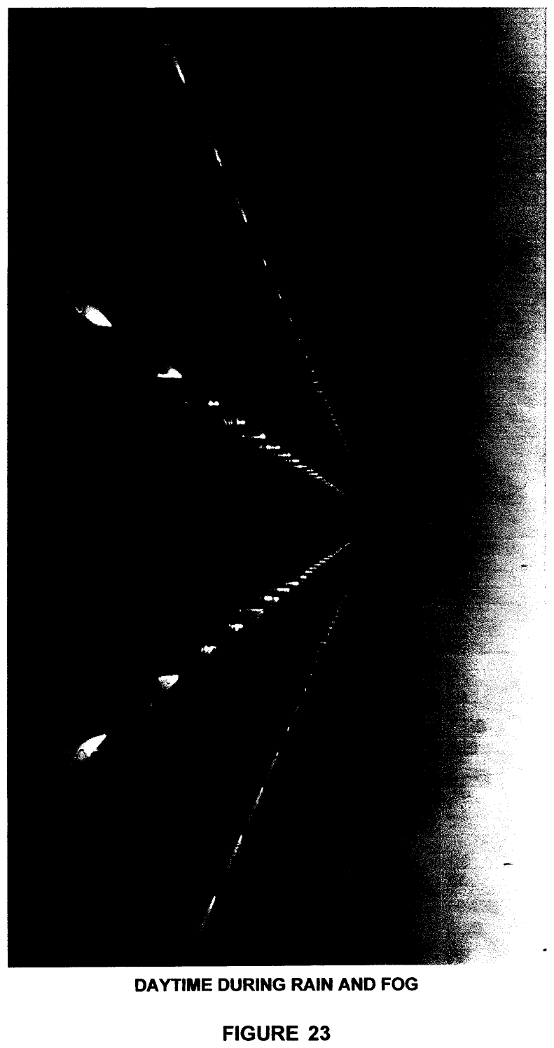

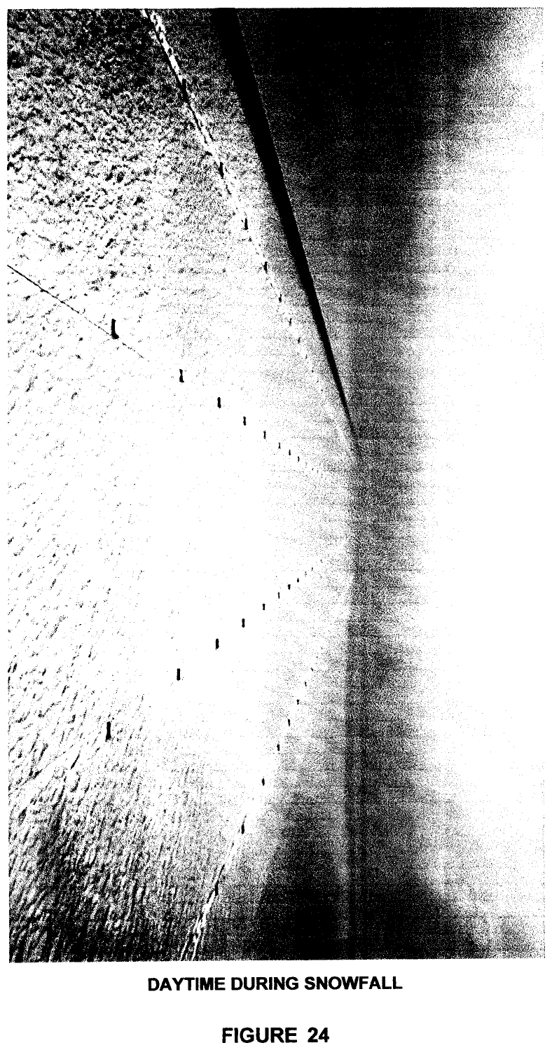

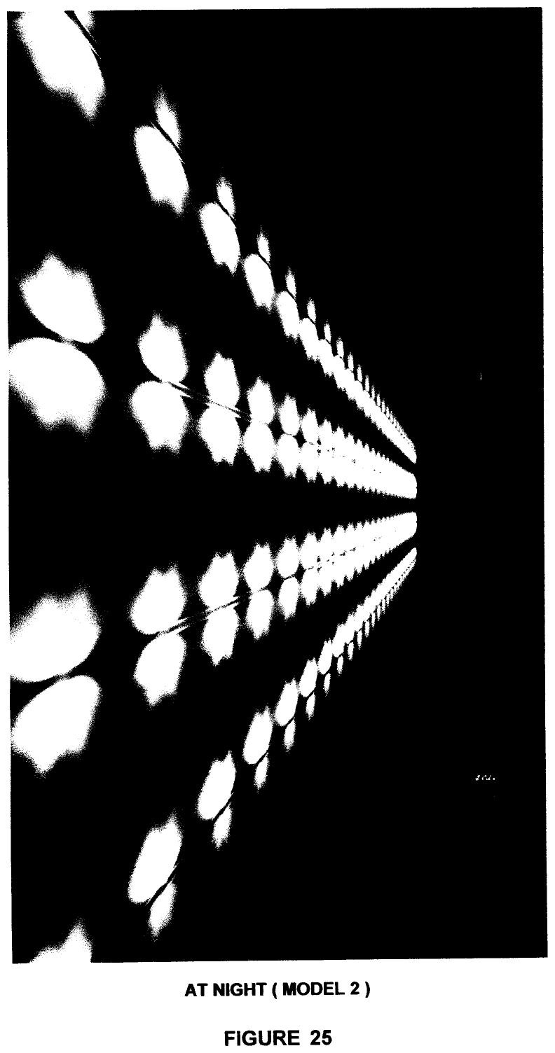

Installed on the highways floor and other roads and is suitable for most of the countries of the world.

The existing road lighting depends on the lighting installed on long poles that depend on regular electricity or solar energy, and both methods require very high costs and long, arduous and expensive work stages as well.

Therefore, we find most of the highways and other travel roads are not lighted.

In some case cars crash into the lighting poles, that means more dangerous.

The present invination discloses a lighting unit fixed on ground, between the paths and depends on Sun light, consists of hollow metal body (1) and monocrystalline solar panels (6), Electronic circuit (5), light sensor (13), humidity sensor (14), LED lights (7a and 7b) in the two sides left and right directed to the paths.

LED colored lights (10-a) and (10-b) fixed on the front and rear sides to show the frontiers of the paths in case of fog or raining or snowing.

The base (2) is under the body (1). They are fixed together by screw through holes (12).

In the bottom there is a hollow cylinder implanted into ground and it is a depot for the batteries pack (4).

The present invination is insulated as international standard (IP68).

The present invention increases safety on various types of land travel roads and suitable for most countries of the world and its cost is low and its installation is very easy because it is placed instead of the Cat's eyes and is installed in the same way as Cat's eyes insallation.

This means that land travel roads in most regions of the world will be lighted and safer.

### TECHNICAL FIELD

The present invination generally relates to lighting unit of the highways and several kinds of roads.

### ARTISTIC BACKGROUND

The lighting of highway and other roads depends on lights fixed on long poles and it works by current electrical. This requires high costs, long and hard work stages.

This kind of lighting consumes a lot of electrical energy that can be used for many other purposes.

There is another kind of highways and other roads lighting fixed on long poles and depends on solar energy and it is very costly, need to hard fixing stages and take many times to do.

Because of the light of the poles in the two kinds, the light should be very strong which increase the cost and the energy consuming.

Therefore, we find most of the highways and other travel roads are not lighted.

The darkness causes many accidents that kill and injure a lot of people because the divers can not see clearly the road and its curves and can not see if there anything on the road like broken vehicles, tires, animals or any things else maybe cause any accidents.

### SUMMARY OF THE INVENTION

According to the present invention, lighting unit is provided, fixed onto the floor of the highways and other roads and may be used inside cities as well.

The lighting unite consists of a metallic body made of hard aluminium, which bears very heavy weights and contains monocrystalline solar panel, an electronic circuit, a light's sensor,

A humidity's sensor, LED lights consuming 1 watt per hour and a group of batteries with a large capacity sufficient to operate 10 days without charging.

The body shall be installed on a base made of same metallic material and the base is a single piece consisting of two parts, the upper section is fixed with the body by screws and the bottom section is a hollow cylinder that is the repository of the battery pack.

The bottom of the base is implanted into the ground and the upper parts is on the surface of the ground.

The lighting unit is installed on the road floor with screws or glue and is on the lines separating the multiple paths as it gives light to the two sides (right and left) to illuminate the road, and also has a light's reflector on the front side.

The solar cells and the electronic circuits are coated with a transparent plastic layer made of a very strong material to bear heavy weights, water and sands.

I put a group of small batteries instead of one large battery to reduce the possibility of malfunctions. If it was one battery and it malfunctioned, the device will stop working, but by dividing it into a group, we guarantee the continued operation of the device.

The side lights (left and right) work at night and turn off during the day.

The coloured headlights work day and night in the event of fog, rain and snow.

The lighting unit installed on the roadside above the yellow line; The lights at the outside of the road are yellow, and the lights on the front side are red.

Solar cells produce 2 watts per hour, meaning that within 6 hours it produces 12 watts, which is sufficient to make lighting for 12 hours at night. If solar cells produce more than 12 watts per day, the excess electricity is stored in batteries that have a total capacity of 20000 Mah and enough to make lighting 10 nights.

The device is insulated against water and dust according to the international standards (IP68). The lighting unit operates at a temperature degree between (−10° C. to +60° C.). In the event of A temperature above +60° C. the batteries are discharged gradually to avoid an explosion.

The present invention shall be made in a streamlined manner, which shall not cause any damage to the tyres and shall not exceed 2 cm in height.

The advantages of the present invention are:—very easy to manufacture, very cheap compared to the current lighting methods, does not require additional stages and installation costs, as it is installed in place of the cat's eyes that currently exist which are used to indicate the boundaries of the paths only.

The present invention illuminates the road floor and clarifies the boundaries of the paths in different weather conditions, making the roads safer and more comfortable for people.

Suitable for most countries of the world.

It is a friend of environment and has no harmful side.

### BRIEF DESCRIPTION OF THE GRAPHICS

To better understand the nature and components of the invention, three models are presented with detailing each of components by providing detailed drawing by numbering the whole parts and clarifying the work and nature of each part.

It is indicated for the model numbering model 1, model 2 and model 3, and each model has 4 detailed drawings in addition to picture of the model in full and pictures that simulate the reality of a street in which the model has been shown in these images the shape of lighting in the road using the current invention.

### DETAILED DESCRIPTION OF THE PREFERRED EMBODIMENT

MODEL 1: figure in the page (1/25)

There are four types (1-A, 1-B, 1-C, 1-D). The four types have almost the same ingredients with some differences depending on where they are installed and all of them are insulated as international standards (IP68).

Among the advantages of this model is the presence of an upper area in the body (1) that helps to place larger solar panels to generate electricity in a larger amount in a short time.

(TYPE 1-A): figure in the page (2/25), the lighting unit consists of several parts:

Body (1) is a hollow metal body made of very strong aluminium to withstand heavy weights so that cars and large vehicles pass over it without bring affected and inside it are installed on the top two Monocrystalline solar panel (6) their minimum Wattage 2W and Output is 6V 350ma.

The light sensor (13) that gives the command to turn OFF the LED lights (soft white) (7a) and. (7b) in the light condition and turn them ON in the dark, knowing that (7a) and 7b are installed on the left and right sides.

Humidity's sensor (14) It gives the command to turn on the LED lights (blue) (10a) and (10b) which are fixed in the front and rear sides, in the case of the percentage of humidity (100%) indicating the presence of fog or rain or snow. and there are under the two Monocrystalline solar panels (6) electronic circuit (5) connected to all the internal parts through appropriate thin wires where connect with the two monocrystalline solar panels (6), Light's sensor (13), Humidity sensor (14), LED light's (soft white) (7a) and (7b) and LED light's (blue) (10a) and (10b) and set of batteries (4) that several batteries connected together to store extra energy in case of clouds or hinder the arrival of sunlight for several days.

Rechargeable battery can be used minimum three years and be charged 2000 times.

Capacity: 20000 mah. Output: 6 v.

And, around the LED lights (soft white) (7a) and (7b) are a reflector (11) made of mirror-shaped plastic to direct the light in an optimal way.

Fixing in front of LED lights (soft white) (7a) and (7b) a layer of transparent hard plastic (8a) and (8b) made of ultra-strong plastic to provide protection for LED lights (soft white) (7a) and (7b). and there is reflective plastic (9a) and (9b) (yellow) on both sides front and rear to reflect the light of incoming cars, and in the middle of it will be hard transparent plastic (8c) and (8d), which the LED lights (blue) (10a) and (10b) passes through.

The base (2) is the part under the body (1) and fixed together by screws through the holes (12).

In the base (2) there is a hole that leads to the second section of the base, which is a hollow cylinder (3) planted in the ground and a it is the depot for the batteries (4) that are surrounded by thermal insulation materials.

Batteries (4) operate at temperatures (−10° C. to 60° C.).

If the temperature exceeds 60° C., the batteries (4) will be discharged gradually to avoid any damage.

In the event that the road is dual, the lighting unit must contain LED lights (blue) (10a) and (10b) to benefit the both sides. If the road is one-way, then there is no need for (10b).

(TYPE 1-B): figure in the page (3/25)

Quite the same as the (1-A) type with one difference is the absence of a humidity sensor (14) where only LED lights (blue) (10a) and (10b) work at darkness with LED lights (soft white) (7a) and (7b).

(TYPE 1-C): figure in the page (4/25)

It is fixed on the right side of road above the yellow line and with the same components of (type 1-A) or (type 1-B) with two difference. Lights (7b) is yellow instead of soft white, and the LED lights (10a) and (10b) are red instead of blue.

(TYPE 1-D): figure in the page (5/25)

It is fixed on the left end of the road above the yellow line and with the same components of (type 1-A) or (type 1-B) with two differences. The colour of lights (7a) is yellow instead of soft white and the LED lights (10a) and (10b) are red instead of blue.

Model 2: figure in the page (7/25)

Referring to Model 2 The overall appearance of Model 2 is semi-circular, to make the light spread wider and illuminate a larger area of the road.

Among the advantages of this model is the presence of an upper area in the body (1) that helps to place larger solar panels to generate electricity in a larger amount in a short time.

There are four types (2-A, 2-B, 2-C, 2-D). The four types have almost the same ingredients with some differences depending on where they are installed and all of them are insulated as international standard (IP68).

(TYPE 2-A): figure in the page (8/25).

The lighting unit consists of several parts:

Body (1) is a hollow metal body made of very strong aluminium to withstand heavy weights so that cars and large vehicles pass over it without bring affected and inside it are installed on the top two Monocrystalline solar panel (6) their minimum Wattage 2W and Output is 6V 350ma.

Light's sensor (13) that gives the command to turn OFF the LED lights (soft white) (7a) and (7b) event of light and turn ON in the dark.

LED lights (soft white) (7a) and (7b) fixed on the right side and left side of the body (1) in curve shape to make good lighting in maximum area of the road.

Humidity's sensor (14) It gives the command to turn on the LED lights (10a) and (10b) in the case of the percentage of humidity is 100% indicating the presence of fog or rain or snow and there are under the two Monocrystalline solar panel (6) electronic circuit (5) connected to all the internal parts through appropriate thin wires where connect with the two Monocrystalline solar panel (6) as well as a set of batteries (4) that several batteries connected together to store extra energy in case of clouds or hinder the arrival of sunlight for several days.

Rechargeable battery can be used minimum three years and be charged 2000 times.

Capacity: 20000 mah.

Output: 6 v.

Light's sensor (13), humidity sensor (14), LED lights (soft white) (7a) and (7b) and LED lights (blue) (10a) and (10b).

And, around there is LED lights (soft white) (7a) and (7b) a reflector (11) made of mirror-shaped plastic to direct the light in an optimal way.

Fixing in front of LED lights (soft white) (7a) and (7b) a layer of transparent hard plastic (8a) and (8b) made of ultra-strong plastic to provide protection for LED lights (soft white) (7a) and (7b) and there is reflective plastic (9a) and (9b) yellow on both sides front and rear to reflect the light of incoming cars and in the middle of it will be hard transparent plastic (8c) and (8d), which the lights (10a) and (10b) passes through.

The base (2) is the part under the body (1) and fixed together by screws through the holes (12). In the base (2) there is a hole that leads to the second section of the base, which is a hollow cylinder (3) planted in the ground and it is the depot for the batteries (4) that several batteries connected together to store extra energy in case of clouds or hinder the arrival of sunlight for several days.

Rechargeable battery can be used minimum three years and be charged 2000 times.

Capacity: 20000 mah. Output: 6 v.

Which are a group of batteries surrounded by thermal insulation materials.

Batteries (4) operate at temperatures (−10° C. to 60° C.).

If the temperature exceeds 60° C., the batteries (4) will be discharged gradually to avoid any damage.

In the event that the road is dual, the lighting unit must contain LED lights (blue) (10a) and (10b) to benefit both sides.

If the road is one-way, then there is no need for LED lights (10b).

(TYPE 2-B): in figure the page (9/25)

Quite the same as the (2-A) type with one difference is the absence of a humidity sensor (14) where only LED lights (blue) (10a) and (10b) work at night with LED lights (soft white) (7a) and (7b).

(TYPE 2-C): figure in the page (10/25)

It is fixed on the right side of road above the yellow line and with the same components of soft white, and the LED lights (10a) and (10b) are red instead of blue.

(TYPE 2-D): figure in the page (11/25)

It is fixed on the left end of the road above the yellow line and with the same components of (type 2-A) or (type 2-B) with two difference. The colour of lights (7a) is yellow instead of instead soft white and the LED lights (10a) and (10b) are red instead of blue.

Model 3: figure in the page (13/25)

The body of this model is currently used in the (Cat's eyes), which is placed between the lanes and the edges of the road and used to reflect the cars lights by using a coloured plastic reflector that shows the boundaries of the paths, In normal weather conditions.

It has no function in lighting the paths of roads and their outer edges.

While the purpose of our present invention is to illuminate all types of roads, especially highway roads, and to clarify the boundaries of road paths in various weather conditions to avoid fatal accidents.

The present invention used old body of the Cat's eyes to reduce the cost and the time to produce it because it is available already.

Because of the small area on the upper side of the body (1) that is not sufficient to put the solar panels enough to generate the required electricity, I put the solar panels on the bottom of the body inside a transparent layer of strong plastic that allows light to pass through it to the solar Panels (6).

Referring to Model 3 there are four types (3-A, 3-B, 3-C, 3-D); The four types have almost the same ingredients with some differences depending on where they are installed and all of them are insulated as international standard IP68.

(TYPE 3-A): in figure the page (14/25):

The lighting unit consists of several parts:

Body (1) is a hollow metal body made of very strong aluminium to withstand heavy weights so that cars and large vehicles pass over it without bring affected, and inside it are installed on the top two Monocrystalline solar panel (6) their Wattage 2W and Output is 6V 350ma.

Lights sensor (13) that gives the command to turn OFF the LED light's (soft white) (7a) and (7b) in the event of light and turn ON in the dark.

The humidity sensor (14) gives the order to turn on the LED lights (blue) (10a) and (10b) when the humidity in the air is 100%, which means there is fog, rain or snow.

And there are under the two solar panel (6) electronic circuit (5) connected to all the internal parts through appropriate thin wires where connect with the two Monocrystalline solar panel (6) Lights sensor (13), humidity sensor (14), LED lights (soft white) (7a) and (7b) and LED lights (blue) (10a) and (10b) and a set of batteries (4) that is several batteries connected together to store extra energy in case of clouds or hinder the arrival of sunlight for several days.

Rechargeable battery can be used minimum three years and be charged 2000 times.

Capacity: 20000 mah. Output: 6 v.

And, around the LED lights (soft white) (7a) and (7b) are reflector (11) made of mirror-shaped plastic to direct the light in an optimal way.

Fixing in front of LED lights (soft white) (7a) and (7b) a layer of transparent hard plastic (8a) and (8b) made of ultra-strong plastic to provide protection for LED lights (soft white) (7a) and (7b) and there is reflective plastic (9a) and (9b) yellow on both sides Front and rear to reflect the light of incoming cars and in the middle of it will be hard transparent plastic (8c) and (8d), which the light of LED lights (10a) and (10b) passes through it.

The base (2) is the part under the body (1) and fixed together by screws through the holes (12). In the base (2) there is a hole that leads to the second section of the base, which is a hollow cylinder (3) planted in the ground and it is the depot for the batteries (4) which are a group of batteries surrounded by thermal insulation materials.

Batteries (4) operate at temperatures (−10° C. to 60° C.).

If the temperature exceeds 60° C., the batteries (4) will be discharged gradually to avoid any damage.

In the event that the road is dual, the lighting unit must contain the LED light's (blue) (10a) and (10b) to benefit both sides.

If the road is one-way, then there is no need for (10b).

(TYPE3-B): figure in the page (15/25)

Quite the same as the (3-A) type with one difference is the absence of a humidity sensor (14) where only LED lights (blue) (10a) and (10b) work at night with LED lights (soft white) (7a) and (7b).

(TYPE 3-C): figure in the page (16/25)

It is fixed on the right side of road above the yellow line and with the same components of (TYPE 3-A) or (TYPE 3-B) with two differences. The colour of the LED lights (7b) is yellow instead of soft white, and the LED lights (10a) and (10b) are red instead of blue.

(TYPE3-D): in figure the page (17/25)

It is fixed on the left end of the road above the yellow line and with the same components of (TYPE 3-A) or (TYPE 3-B) with two differences. The colour of LED lights (7a) is yellow instead of soft white and the LED tights (10a) and (10b) are red instead of blue.

1.-7. (canceled)

8. A road lighting device for highways, comprising:
a metal body made of aluminum comprises two electronic circuits that regulate all functions in the lighting device;
a light sensor for controlling lights of the lighting device, wherein the sensor turns on the lights in dark conditions, and turns the light off during daylight conditions;
a humidity sensor for measuring a percentage of humidity in the air;
an energy source, wherein the energy source is a monocrystalline solar panel and a lithium battery;
wherein the electrical circuits and the light sensor are placed inside a layer of transparent plastic; and
a base positioned beneath the body and made of aluminum, wherein the body and the base are fixed and sealed together by screws through holes, wherein the base, in a middle portion thereof, includes a circular hole, that reaches to a bottom portion of the base, which is a hollow cylinder for storing a battery pack that includes several batteries connected together to store extra energy in case of cloudy conditions or hindrance of an arrival of sunlight for several days;
wherein the batteries are rechargeable for at least three years;
wherein the lighting device is semi-circular, to make the light spread out wider and illuminate a larger area of the road.

9. The road lighting device for highways according to claim 8, wherein the humidity sensor is substituted by colored LED lights for determining a path of the road during the dark conditions only, and non-colored LED lights, without being affected by the weather.

10. The road lighting device for highways according to claim 9, wherein the lighting device is fixed on a right side of the road on a road line and the non-colored LED lights includes a first side LED light oriented in an outward direction from the right side and a second side LED light in soft white that is oriented towards the road, wherein the colored LED lights are in a red color so as to show track boundaries.

11. The road lighting device for highways according to claim 8, wherein the lighting device is fixed on the left side of the road on a road line and includes a first LED side light in yellow that is oriented in an outward direction from the left side and a second LED side light in soft white that is oriented towards the road, wherein colored LED lights are in a red color so as to show track boundaries.

12. The road lighting device for highways according to claim 8, wherein the lighting device is semi-circular for spreading the light out in a wide path and illuminating a large area of the road.

13. The road lighting device for highways according to claim 8, wherein the rechargeable battery can be used a minimum of three years, can be charged 2000 times, have a capacity of 20000 mAh and an output of 6 v.

14. A road lighting device for highways, comprising:
a metal body made of aluminum;
two monocrystalline solar cells inside the body for producing two watts per hour;
two electronic circuits regulating all functions of the lighting device;
a light sensor, wherein the sensor sends orders to a light to work at night and turn off during the day;
a humidity sensor for measuring a percentage of humidity in the air, wherein when the humidity is 100% that means there is fog, rain, or snowfall, wherein in this case, the humidity sensor sends an order to turn on LED lights;
solar cells;
electrical circuits;
wherein the light sensor are placed inside a layer of transparent plastic;
a base beneath the body, wherein the base is made of aluminum, and the body and the base are fixed together by screws through holes, wherein a middle portion of the base includes a circular hole, that reaches to a bottom portion thereof, that is a hollow cylinder for storing a battery pack that includes several batteries connected together for storing extra energy in case of cloudy conditions or hindrance of an arrival of sunlight for several days, and the batteries include a rechargeable battery that can be used a minimum of three years, can be charged 2000 times, has a capacity of 20000 mAh and an output of 6 v.
